(19) United States
(12) Patent Application Publication
(10) Pub. No.: US 2002/0191263 A1
(43) Pub. Date: Dec. 19, 2002

(54) Method and apparatus for optical data signaling using dark photodiode

(75) Inventors: Chinh L. Hoang, San Diego, CA (US); Michael J. Brunolli, Escondido, CA (US)

Correspondence Address: Pillsbury Winthrop LLP, 1600 Tysons Boulevard, McLean, VA, 22102, US

(73) Assignee: Nurlogic Design, Inc.

(21) Appl. No.: 10/172,387

(22) Filed: Jun. 14, 2002

Related U.S. Application Data
(60) Provisional application No. 60/298,427, filed on Jun. 14, 2001.

(51) Int. Cl. H04B 10/12; H04B 10/06

(52) U.S. Cl. 359/189; 359/173

(57) ABSTRACT

An optical data signaling apparatus includes a trans-impedance amplifier for receiving a data signal current produced by a sensing photodiode in response to an optical data signal and an ambient current produced by a dark photodiode. Preferably, the dark photodiode has the same performance and manufacturing characteristics as the photodiode sensing the optical data signal, but is masked from receiving any light. The trans-impedance amplifier is configured to receive the ambient current from the dark photodiode as a first differential input and the data signal current from the sensing photodiode as a second differential input, the first differential input thus serving to cancel noise and environmental effects of the photodiodes, and allowing the amplifier to produce a stable and accurate differential voltage in response to the data signal current. An optical data signaling method includes receiving a data signal current produced by a sensing photodiode in response to an optical data signal, receiving an ambient current produced by a dark photodiode, using the ambient current as a differential reference for the data signal current, and producing a stable differential voltage in response to the data signal current by cancelling effects of noise and environmental factors represented by the ambient current.

### CROSS-REFERENCE TO RELATED APPLICATIONS

The present application is based on, and claims priority from, U.S. appln. Ser. No. 60/298,427, filed Jun. 14, 2001, commonly owned by the assignee of the present application, the contents of which are incorporated herein by reference.

### FIELD OF THE INVENTION

The present invention relates generally to optical data signaling, and more particularly, to a method and apparatus for translating a current output from a photodiode that varies in accordance with a received optical data signal to a differential voltage output using a dark photodiode to provide a bias current source.

### BACKGROUND OF THE INVENTION

Trans-impedance amplifiers (TIA's) are used in optical data signaling applications such as fiber optics receiver circuits to translate the current output of a photodiode into a voltage output representative of a sensed optical signal. As shown in FIG. 1, an optical receiver 100 includes a photodiode 104 that senses light 112 associated with an optical data signal impinging on it from, for example, an optical fiber 102. The current output from the photodiode 104 will vary in proportion to the intensity of the impinging light. In one example optical data signaling application using on-off keying, the optical receiver is synchronized with a transmitter (e.g. via frame alignment patterns within the data) that transmits optical signal data by a series of light pulses 110 at a specified wavelength(s). Accordingly, data having a first logic state (corresponding to a binary “1”, for example) is signaled by transmitting a pulse of light at an expected pulse location/time (e.g. the period of a 1 Gbps optical data signal), and data having a second logic state (corresponding to a binary “0”, for example) is signaled by transmitting no or low-level light at an expected pulse location/time. It should be noted that multi-level keying applications would use greater than two logic states per symbol, but for ease of illustration, the present application will be mainly described in conjunction with on-off keying applications.

The output of the photodiode is supplied to TIA 106 which translates the received photodiode current into a voltage output. In some applications (e.g. LVDS or CML), the translated voltage output is further supplied to a main or limiting amplifier 108 to provide a differential signaling output to other electronic circuits. See generally, H. Kim et al., “A Si BiCMOS Transimpedance Amplifier for 10-Gb/s SONET Receiver,” IEEE Journ. Solid-State Circuits, Vol. 36, No. 5, May 2001.

FIG. 2 illustrates an example application of the above scheme in a conventional optical receiver. As shown in FIG. 2, an optical receiver 200 includes a photodiode 202 coupled to one input of TIA 204 and a voltage reference 206 coupled to the complementary input of TIA 204. A feedback resistor 208 is coupled between the photodiode input and one output of TIA 204. The outputs of TIA 204 may be further provided to a differential limiting or main amplifier (not shown) for differential signaling applications.

As discussed above, photodiode 202 senses light impinging on it and produces a current output in proportion to the intensity of the impinging light. In one example where photodiode 202 is a PIN or avalanche type, photodiode 202 will produce an output ranging from about 2 microamps to hundreds of microamps.

The current input to the TIA 204 will thus fluctuate in magnitude in accordance with the data pattern signaled on the fiber and sensed by the photodiode 202. To produce an accurate voltage output from TIA 204 in accordance with the current input, the voltage reference 206 should be set so as to provide an optimal bias. For example, the voltage reference may be set in accordance with the average current input. However, the average current input in actual operation will vary due to a number of factors that are difficult to control or predict (or impossible after the circuit has been fabricated) such as the actual signaled data pattern, temperature effects, and manufacturing processes. Accordingly, the performance of the receiver will become less accurate and reliable than desired. These problems are exacerbated when the output of the TIA is supplied to a differential signaling driver circuit.

FIG. 3 illustrates another optical receiver that aims at overcoming some of the above problems. As shown in FIG. 3, receiver 300 includes a TIA 302 that provides a differential signaling output in accordance with current input from photodiode 304. In this example, the DC bias is automatically set by the characteristics of the amplifier and the feedback, so a reference voltage is not needed. Accordingly, feedback resistors 306 and 308 are provided between the differential outputs and the two inputs of TIA 302.

In operation of the circuit 300, from a small-signal standpoint, as the voltage at the input of amplifier 302 coupled to photodiode 304 changes due to changes in current corresponding to light impinging thereon, such changes will be reflected in the associated output. By operation of amplifier 302, the complementary input will tend toward being equal to the input coupled to photodiode 304, so the complementary outputs will follow each other at an offset, thus providing a differential output that is not dependent upon an input DC bias.

Although this optical receiver design eliminates the need to provide an accurate and controlled voltage reference for biasing the amplifier, the asymmetry between the circuits coupled to the inputs of TIA 302 leads to other problems. For example, associated with photodiode 304 are parasitic elements 310. These elements are coupled to one input of the amplifier but not the other. Accordingly, although the DC bias of the circuit will effect the differential outputs symmetrically, there will be AC asymmetry between the differential outputs. Further, noise will couple differently to the inputs and thus to the differential outputs. This is a serious problem for a differential signaling scheme which by its design aims to overcome noise effects by allowing for symmetric noise at each output to cancel out.

### SUMMARY OF THE INVENTION

The present invention relates to methods and apparatuses for optical data signaling.

According to one aspect of the invention, an optical data signaling apparatus includes a trans-impedance amplifier for receiving a data signal current produced by a sensing photodiode in response to an optical data signal and an ambient current produced by a dark photodiode. Preferably, the dark photodiode has the same performance and manufacturing characteristics as the photodiode sensing the optical data signal, but is masked from receiving any light. The trans-impedance amplifier is configured to receive the ambient current from the dark photodiode as a first differential input and the data signal current from the sensing photodiode as a second differential input, the first differential input thus serving to cancel noise and environmental effects of the photodiodes, and allowing the amplifier to produce a stable and accurate differential voltage in response to the data signal current. In accordance with another aspect of the invention, an optical data signaling method includes receiving a data signal current produced by a sensing photodiode in response to an optical data signal, receiving an ambient current produced by a dark photodiode, using the ambient current as a differential reference for the data signal current, and producing a stable differential voltage in response to the data signal current by cancelling effects of noise and environmental factors represented by the ambient current.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram illustrating the reception and processing of optical data signals in accordance with known techniques;

FIG. 2 is a circuit diagram illustrating a conventional implementation of a photodiode and trans-impedance amplifier in an optical data signaling receiver;

FIG. 3 is a circuit diagram illustrating an example implementation of a photodiode and trans-impedance amplifier that aims at solving some of the problems afflicting the circuit in FIG. 2;

FIG. 4 is a circuit diagram illustrating an example implementation of an optical data signaling receiver including a dark photodiode in accordance with the principles of the present invention; and

FIG. 5 is a circuit diagram illustrating an example implementation of a differential trans-impedance amplifier such as that illustrated in FIG. 4.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the known components referred to herein by way of illustration.

In accordance with an aspect of the present invention, an optical data signaling circuit includes a dark photodiode in addition to the optical signal sensing photodiode that together establish a differential input to the optical signal input to a trans-impedance amplifier.

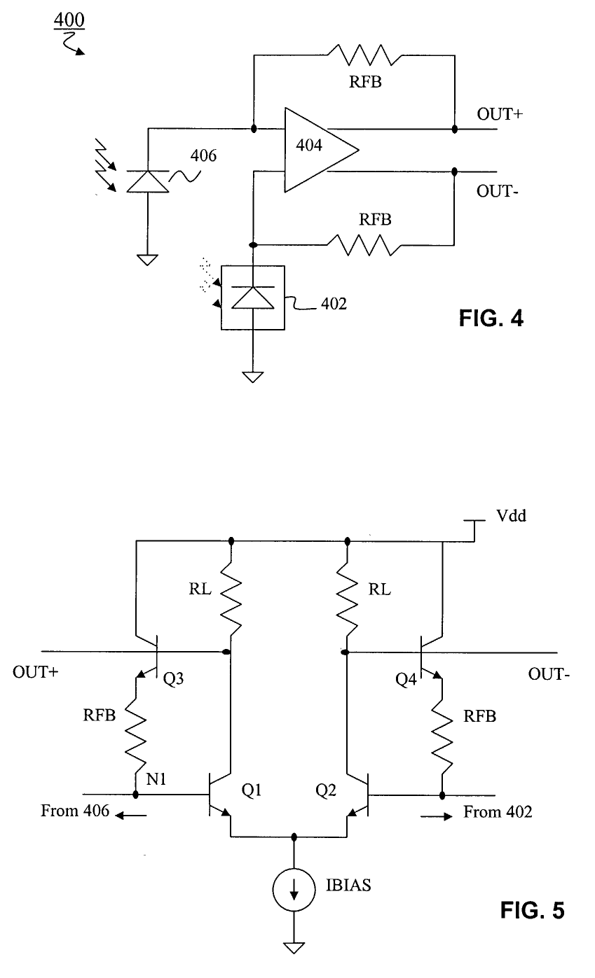

An example receiver in accordance with the present invention is illustrated in FIG. 4. As shown in FIG. 4, optical signal receiver 400 includes a dark photodiode 402 coupled to one input of TIA 404. Preferably, dark photodiode 402 has the same performance and physical characteristics of photodiode 406 which senses the optical signal input to the receiver. For example, photodiode 406 and dark photodiode 402 are both implemented by a PIN photodiode having identical or substantially similar characteristics. As used herein, “dark” means that photodiode 402 is configured so that no light impinges thereon. This can be done in many ways, for example, covering it with an opaque material such as metal or paint. Although FIG. 4 shows the photodiodes 402, 406 connected in a “common-anode” configuration, the present invention as will be described in more detail below is not limited to such a configuration, but can be extended to other configurations, such as “common-cathode” configurations.

As should be apparent, in on-off keying and other applications, photodiode 406 provides a low magnitude current output during an “off” state of the optical data signal, and a high magnitude current output during an “on” state of the optical data signal. The values of the “low” and “high” currents will depend on the link budget, extinction ratio and the particular application. For example, in a short distance application where an “on” state corresponds to a current as high as 1 milliamp, but typically about 50 microamps, an “off” state may correspond to no more than about 15% of the “on” value. However, in longer distance applications where propagation losses are higher, an “on” state may correspond to only a few microamps, and an “off” state may correspond to a current less than 1 microamp. Those skilled in the art will understand the various alternative applications and implementations.

Regardless of the application, dark photodiode 402 provides a low but non-zero current output below which the output of photodiode 406 should never fall, even during an “off” state of the optical data signal. The term “ambient” or “reference” current or output will be used to refer to this current output provided by the dark photodiode. However, it should be noted that this low ambient or reference output is not necessarily constant, but may vary over time due to varying temperature, environmental and noise effects (e.g. due to supply, ground, substrate coupling, etc.), for example. But, in an example where the dark photodiode 402 is substantially similar to photodiode 406, such effects will be experienced similarly by both photodiodes 402 and 406, and thus be effectively canceled out so as not to materially adversely impact the performance of receiver 400.

It should be further noted that in the example implementation where dark photodiode 402 and photodiode 406 are substantially similar, dark photodiode 402 will further include parasitic elements, such as parasitic elements 310 as described in connection with FIG. 3, that are substantially similar to the parasitic elements associated with photodiode 406. Accordingly, problems due to the mismatching of AC and DC loads at the inputs of the TIA that afflict other solutions can be avoided.

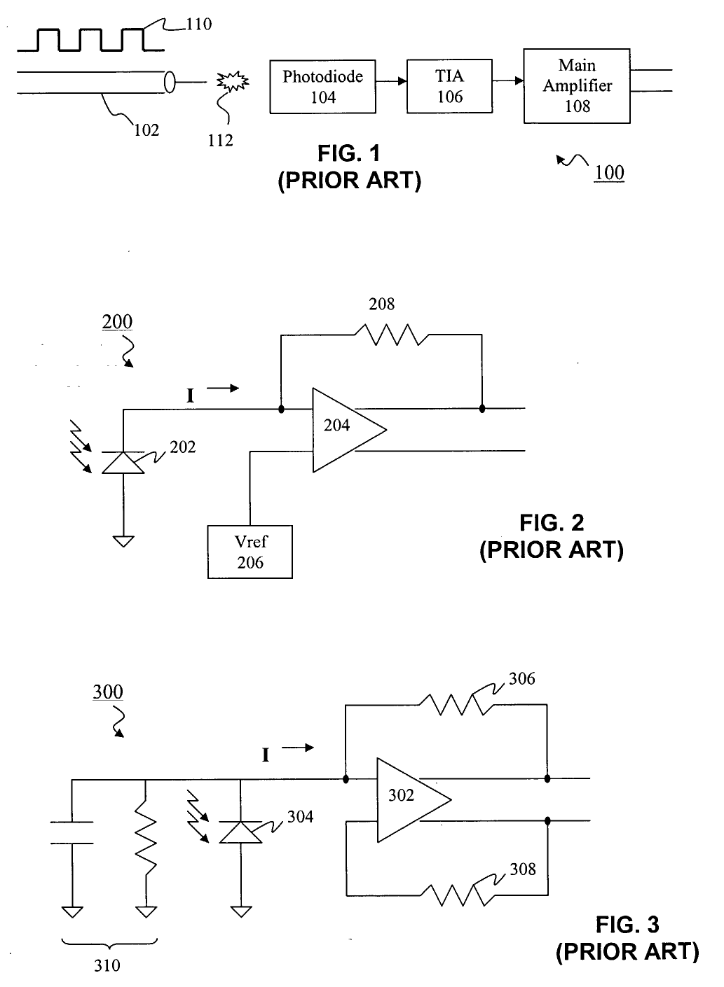

It should be still further noted that, although not shown in the high-level diagrams of FIGS. 1 to 4, additional DC offset cancellation circuitry may be included to further account for the differences at the inputs. Such circuitry is used to balance the average DC currents at the inputs. Alternatively, a DC block may be provided on the photodiode. Those skilled in the art are aware of such implementation details and so even further descriptions thereof are not necessary for an understanding of the present invention.

An example of a circuit that can be used to implement TIA 404 for use in optical receiver 400 is further illustrated in FIG. 5. As shown in FIG. 5, inputs from photodiode 406 and dark photodiode 402 in the example “common-anode” configuration are provided to transistors Q1 and Q2, respectively, and are used to provide amplified outputs OUT+ and OUT−. As further shown in FIG. 5, collectors of transistors Q1 and Q2 are coupled to respective output nodes OUT+ and OUT−, which are both further coupled to voltage source Vdd via respective load resistors RL, and the emitters of transistors Q1 and Q2 are commonly connected to a bias current supply IBIAS. TIA 404 further includes feedback resistors RFB which are respectively coupled between the output nodes OUT+ and OUT− and the bases of transistors Q1 and Q2 via respective transistors Q3 and Q4.

In the example implementation of TIA 404 where photodiode 406 is a PIN type photodiode that produces a current output depending on the light intensity of the received optical signal (and dark photodiode 402 thus produces an ambient current output), Vdd is 3.3 V and IBIAS is about 1 mA. The values of the other amplifier components are preferably designed such that the bandwidth of the amplifier matches the desired bit rate of the optical data signal. Such design considerations are within the ordinary skill in the art.

In operation of TIA 404, depending on a difference between the inputs from photodiodes 406 and 402 due to the varying intensity of light impinging on photodiode 406, Q1 will turn off more than Q2 in varying amounts. This pulls the voltage at node N1 at the base of Q1 down, and causes more current from common current source IBIAS to flow through the conduction path including Q2 than the conduction path including Q1. This causes a varying voltage differential to be established between output nodes OUT+ and OUT− due to the different voltage drops between the identical resistances RL in the different conduction paths including Q1 and Q2.

In operation of the overall receiver 400, therefore, dark photodiode 402 acts to provide an ambient output that, together with the output from the sensing photodiode 406, will establish a differential between the inputs to TIA 404. As light corresponding to an optical data signal impinges on photodiode 406, photodiode 406 will provide a current output that has a magnitude corresponding to the intensity of the impinging light, thus establishing a differential between the signal input and the ambient current input to TIA 404. Depending on the amount of differential between the current inputs to TIA 404, TIA 404 will thus produce a corresponding differential voltage across its outputs. This differential output is improved over prior art techniques because noise and parasitic factors will couple to the inputs similarly, thus affecting the outputs OUT+ and OUT− similarly and providing a stable and accurate differential output.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims include such changes and modifications.

What is claimed is:

1. An optical data signaling apparatus, comprising:
a trans-impedance amplifier having a pair of inputs and a pair of outputs, the amplifier producing a differential voltage between the pair of outputs in response to a current differential between the pair of inputs;
a sensing photodiode that provides a data signal current to one of the amplifier inputs in accordance with a received optical signal; and
a dark photodiode that provides an ambient current to the other of the amplifier inputs, the current differential being a difference between the data signal current and the ambient current.

2. An optical data signaling apparatus according to claim 1, wherein the sensing photodiode and the dark photodiode are both comprised of substantially the same photodiode.

3. An optical data signaling apparatus according to claim 2, wherein the sensing photodiode and the dark photodiode are both comprised of substantially the same parasitic elements.

4. An optical data signaling apparatus according to claim 1, wherein the sensing photodiode and the dark photodiode are both comprised of a PIN photodiode.

5. An optical data signaling apparatus according to claim 1, wherein the sensing photodiode and the dark photodiode are both comprised of an avalanche-type photodiode.

6. An optical data signaling apparatus according to claim 1, wherein the sensing photodiode and the dark photodiode are arranged in a common anode configuration.

7. An optical data signaling apparatus according to claim 1, wherein the sensing photodiode and the dark photodiode are arranged in a common cathode configuration.

8. An optical data signaling apparatus according to claim 1, wherein the trans-impedance amplifier includes:
a first conduction path coupled between the one amplifier input and one of the amplifier outputs; and
a second conduction path coupled between the other amplifier input and the other of the amplifier outputs,
wherein the differential voltage is established by an amount of current drawn in each respective conduction path in accordance with the current differential.

9. An optical data signaling apparatus according to claim 1, wherein the differential voltage is in accordance with one of a LVDS and a CML signaling standard.

10. An optical data signaling apparatus according to claim 8, wherein the differential voltage is in accordance with one of a LVDS and a CML signaling standard.

11. An optical data signaling apparatus according to claim 8, further comprising a pair of feedback paths respectively coupled between the pair of inputs and pair of outputs.

12. An optical data signaling apparatus, comprising:
means for receiving a data signal current corresponding to a received optical signal from a sensing photodiode;
means for receiving an ambient current from a dark photodiode;
means for establishing a differential between the data signal current and the ambient current;
means for providing a differential voltage in accordance with the established differential.

13. An optical data signaling apparatus according to claim 12, wherein the sensing photodiode and the dark photodiode are both comprised of substantially the same photodiode.

14. An optical data signaling apparatus according to claim 13, wherein the sensing photodiode and the dark photodiode are both comprised of substantially the same parasitic elements.

15. An optical data signaling apparatus according to claim 12, wherein the sensing photodiode and the dark photodiode are both comprised of a PIN photodiode.

16. An optical data signaling apparatus according to claim 12, wherein the sensing photodiode and the dark photodiode are both comprised of an avalanche-type photodiode.

17. An optical data signaling apparatus according to claim 12, wherein the sensing photodiode and the dark photodiode are arranged in a common anode configuration.

18. An optical data signaling apparatus according to claim 12, wherein the sensing photodiode and the dark photodiode are arranged in a common cathode configuration.

19. An optical data signaling apparatus according to claim 12, further including:
means for providing a first conduction path coupled to the means for receiving the data signal current; and
means for providing a second conduction path coupled to the means for receiving the ambient current,
wherein the means for establishing the differential includes means for comparing an amount of current drawn in each respective conduction path.

20. An optical data signaling apparatus according to claim 12, wherein the differential voltage is in accordance with one of a LVDS and a CML signaling standard.

21. An optical data signaling apparatus according to claim 19, wherein the differential voltage is in accordance with one of a LVDS and a CML signaling standard.

22. An optical data signaling method, comprising:
receiving a data signal current corresponding to a received optical signal from a sensing photodiode;
receiving an ambient current from a dark photodiode;
establishing a differential between the data signal current and the ambient current;
providing a differential voltage in accordance with the established differential.

23. An optical data signaling method according to claim 22, wherein the sensing photodiode and the dark photodiode are both comprised of substantially the same photodiode.

24. An optical data signaling method according to claim 23, wherein the sensing photodiode and the dark photodiode are both comprised of substantially the same parasitic elements.

25. An optical data signaling method according to claim 22, wherein the sensing photodiode and the dark photodiode are both comprised of a PIN photodiode.

26. An optical data signaling method according to claim 22, wherein the sensing photodiode and the dark photodiode are both comprised of an avalanche-type photodiode.

27. An optical data signaling method according to claim 22, further comprising the step of arranging the sensing photodiode and the dark photodiode in a common anode configuration.

28. An optical data signaling method according to claim 22, further comprising the step of arranging the sensing photodiode and the dark photodiode in a common cathode configuration.

29. An optical data signaling method according to claim 22, wherein the step of establishing the differential includes comparing an amount of current drawn in respective conduction paths associated with the data signal current and the ambient current.

30. An optical data signaling method according to claim 22, wherein the differential voltage is in accordance with one of a LVDS and a CML signaling standard.

31. An optical data signaling method according to claim 29, wherein the differential voltage is in accordance with one of a LVDS and a CML signaling standard.
